(19) United States
(12) Patent Application Publication
(10) Pub. No.: US 2006/0229369 A1
(43) Pub. Date: Oct. 12, 2006

(54) Use of 2-hydroxy-2-sulfinato acetic acid or the salts thereof as an initiator in w/o emulsions

(75) Inventors: Jurgen Frank, Ludwigshafen (DE); Gunter Renz, Freinsheim (DE); Eberhard Schupp, Grunstadt (DE); Bernhard Steinmetz, Limburgerhof (DE); Karl Bayer, Einselthum (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/568,777

(22) PCT Filed: Aug. 20, 2004
(86) PCT No.: PCT/EP04/09358

§ 371 Date: Feb. 21, 2006

(30) Foreign Application Priority Data
Aug. 21, 2003 (DE) 103 38 447.2

(51) Int. Cl. B01D 17/05

(52) U.S. Cl. 516/155

(57) ABSTRACT

Process for the preparation of homopolymers or copolymers by homopolymerization or copolymerization of free-radically polymerizable water-soluble and/or water-dispersible monomers, optionally with further comonomers and optionally with at least one crosslinker, in an inverse emulsion polymerization in the presence of at least one redox initiator pair comprising an oxidizing agent and a reducing agent, where the reducing agent is 2-hydroxy-2-sulfinatoacetic acid and/or salt thereof; homopolymers or copolymers preparable by the process according to the invention, water-in-oil emulsions which comprise at least one homopolymer or copolymer according to the invention, solid compositions which comprise at least one homopolymer or copolymer according to the invention, the use of 2-hydroxy-2-sulfinatoacetic acid and/or salt thereof as reducing agent in a process for the preparation of homopolymers or copolymers; the use of the water-in-oil emulsion comprising at least one homopolymer or copolymer according to the invention for the thickening of aqueous solutions, and the use of 2-hydroxy-2-sulfinatoacetic acid and/or salt thereof as reducing component of a redox initiator pair comprising an oxidizing agent and a reducing agent for avoiding induction times during inverse emulsion polymerization.

The present invention relates to a process for the preparation of homopolymers or copolymers by homopolymerization or copolymerization of free-radically polymerizable water-soluble and/or water-dispersible monomers, optionally with further comonomers and optionally with at least one crosslinker, in an inverse emulsion polymerization in the presence of at least one redox initiator pair, to homopolymers or copolymers preparable by the process according to the invention, to water-in-oil emulsions which comprise at least one homopolymer or copolymer according to the invention, to solid compositions which comprise at least one homopolymer or copolymer according to the invention, to the use of a sulfinic acid compound as reducing agent in a process for the preparation of homopolymers or copolymers by homopolymerization or copolymerization of free-radically polymerizable water-soluble and/or water-dispersible monomers, optionally with further comonomers and optionally with at least one crosslinker, in an inverse emulsion polymerization, to the use of the water-in-oil emulsion comprising at least one homopolymer or copolymer according to the invention for the thickening of aqueous solutions, and to the use of a sulfinic acid compound as reducing component of a redox initiator pair comprising an oxidizing agent and a reducing agent for avoiding induction times during inverse emulsion polymerization.

Water-in-oil emulsions (W/O emulsions) are generally made up of an organic, stationary phase of the emulsion, generally an inert hydrophobic liquid (oil phase) which comprises an aqueous phase stabilized by emulsifiers or protective colloids and comprising water-soluble homopolymers or copolymers, as mobile phase. Such W/O emulsions are of interest, inter alia, as thickeners for aqueous systems. For this purpose, the W/O emulsions are inverted to an oil-in-water emulsion (O/W emulsion) and release of the homopolymers or copolymers brings about a thickening effect.

U.S. Pat. No. 5,216,070 relates to a process for the preparation of W/O emulsions of water-soluble polymers by emulsion polymerization of the corresponding monomers in the presence of an initiator and of a polysiloxane-polyalkylene-polyether copolymer as emulsifier. The initiator system used, in particular for the preparation of W/O emulsions for the cosmetic sector, skincare sector or haircare sector, is a redox initiator system comprising tert-butyl hydroperoxide/ascorbic acid.

EP-A 0 100 693 relates to fat-soluble redox initiator systems which can be used in the inverse emulsion polymerization of water-soluble vinyl monomers. These redox initiator systems comprise an organic hydroperoxide and a thionyl chloride. With the help of this fat-soluble redox initiator system, easily reproducible and controllable polymerizations at low temperatures to give polymers of constant quality on an industrial scale are possible.

GB-A 2 093 464 relates to a chemically initiated inverse emulsion polymerization. In this process, prior to the start of the polymerization, NaCl, NaBr, UCl or UBr are added to the aqueous phase of a W/O emulsion, giving polymers with increased molecular weight in short reaction times and with high conversions. The polymerization can be carried out in the presence of water-soluble redox initiators, such as bromate/bisulfite or metabisulfite, persulfate/bisulfite and bisulfite/tert-butyl hydroperoxide.

A disadvantage of the inverse emulsion polymerization processes known from the prior art using redox initiators is often the occurrence of an induction period of the polymerization, as a result of which polymers with disadvantageous product properties, such as poor speck values and gel body values, are obtained. This induction period can often only be avoided by adding transition metal salts, for example iron(II) salts.

So-called specks are polymer particles which arise during the polymerization and exceed a certain size. They are separated off by filtration during purification of the W/O emulsion. High speck contents thus result in increased production costs due to increased filtration expenditure.

Gel bodies are particles which form during use, i.e. during inversion of the W/O emulsion, for example for the preparation of a printing paste, and exceed a certain size.

It is an object of the present invention to therefore provide water-soluble homopolymers or copolymers which have good product properties, in particular good speck and gel body values. A further object is to provide a process for the preparation of the homopolymers or copolymers, and W/O emulsions comprising these and having a low speck content and low gel body numbers, without impairment of the other properties of the W/O emulsion.

We have found that this object is achieved by a process for the preparation of water-soluble or water-swellable homopolymers or copolymers by homopolymerization or copolymerization of free-radically polymerizable water-soluble and/or water-dispersible monomers, optionally with further comonomers and optionally with at least one crosslinker, in an inversion emulsion polymerization in the presence of at least one redox initiator pair comprising an oxidizing agent and a reducing agent.

The process according to the invention is notable for the fact that the reducing agent is 2-hydroxy-2-sulfinatoacetic acid and/or salt thereof, preferred salts being alkali metal and alkaline earth metal salts, with Li, Na, K being particularly preferably suitable and 2-hydroxy-2-sulfinatoacetic acid disodium salt being very particularly preferred.

With the help of the use of 2-hydroxy-2-sulfinatoacetic acid and/or salt thereof as reducing agent, the homopolymerization or copolymerization takes place according to the process of the invention without occurrence of an induction period. As a result, the desired advantageous product properties, in particular good speck and gel body values, of the polymers and W/O emulsions prepared by this process are achieved. No transition metals of any kind are thus required in the process according to the invention, as a result of which discoloration of the W/O emulsion and polymers is avoided.

2-Hydroxy-2-sulfinatoacetic acid and salts thereof are already known in the prior art.

For example, DE-A 197 43 759 relates to the use of 2-hydroxy-2-sulfinatoacetic disodium salt as reducing agent and as cocatalyst in emulsion polymerizations or redox catalyst systems in the manufacture of plastics. In this process, 2-hydroxy-2-sulfinatoacetic acid disodium salt is used as a replacement for formaldehyde sulfoxylates, in particular sodium formaldehyde sulfoxylate since, in contrast to the formaldehyde sulfoxylates, no formaldehyde is eliminated during the reduction operation of 2-hydroxy-2-sulfinatoacetic acid or its sodium salt; formaldehyde must not be present in many plastics or polymer dispersions.

US 2002/00 68 791 A1 relates to a process for the preparation of a polymer by aqueous emulsion polymerization in which at least one ethylenically unsaturated monomer is polymerized in the presence of a redox initiator system constructed from a water-soluble oxidizing agent, a water-insoluble oxidizing agent and a sulfinic acid or salts thereof as reducing agent. With the help of this process, a reduction in the residual content of ethylenically unsaturated monomer in the desired aqueous polymer emulsion is achieved. Inter alia, 2-hydroxy-2-sulfinatoacetic acid and salts thereof are mentioned as sulfunic acid compound.

EP-A 1 201 685 relates to binders which comprise polymerized units of N-methylolacrylamide and have a reduced content of formaldehyde. The polymers are prepared by emulsion polymerization, the initiator used being a redox initiator system which comprises, as reducing agent, the glycolic acid adduct of sodium sulfite, 2-hydroxy-2-sulfinatoacetic acid disodium salt.

In the prior art, 2-hydroxy-2-sulfinatoacetic acid or salt thereof is used as reducing agent of a redox initiator pair. However, the use relates merely to the use as reducing agent in the emulsion polymerization in which water is used as the continuous phase. In this connection, 2-hydroxy-2-sulfinatoacetic acid or salt thereof is used as a replacement for formaldehyde-forming reducing agents.

The use of 2-hydroxy-2-sulfinatoacetic acid and/or salt thereof in the inverse emulsion polymerization, in which the continuous phase used is an inert organic solvent, is not known from the prior art. Surprisingly, it has been found that when using 2-hydroxy-2-sulfinatoacetic acid and/or salt thereof in the inverse emulsion polymerization, the occurrence of induction periods can be avoided without the use of transition metals being necessary.

In the text below, the terms homopolymers or copolymers are summarized as (co)polymers, and the terms homopolymerization or copolymerization are summarized as (co)polymerization.

Suitable monomers are all water-soluble and/or water-dispersible compounds which can be converted by free-radical polymerization. Preference is given to using free-radically polymerizable carboxylic acids, or salts or derivatives thereof as free-radically polymerizable monomers.

Suitable free-radically polymerizable carboxylic acids, or salts or derivatives thereof are generally allylically or vinylically unsaturated carboxylic acids, or salts or derivatives thereof.

Suitable allylically or vinylically unsaturated carboxylic acids, or salts or derivatives thereof are preferably allylically or vinylically unsaturated mono- or dicarboxylic acids, or salts or derivatives thereof. Particular preference here is given to vinylically unsaturated mono- or dicarboxylic acids, the salts of the abovementioned acids, in particular the alkali metal and ammonium salts, the salts of polymeric amines (i.e. polymeric ammonium salts) or mixtures of alkali metal and alkaline earth metal salts, and also derivatives of said carboxylic acids, in particular esters, amides, nitriles or anhydrides thereof. Preference is given to using α,β-monoethylenically unsaturated mono- or dicarboxylic acids having 3 to 6 carbon atoms, such as acrylic acid and/or methacrylic acid, maleic acid, fumaric acid or itaconic acid, or salts or derivatives thereof.

Particularly preferably used acids or salts thereof are acrylic acid, methacrylic acid, sodium acrylate, ammonium acrylate, sodium methacrylate or ammonium methacrylate, with acrylic acid or ammonium acrylate being very particularly preferred.

Particularly preferably used esters are esters of the abovementioned acids with C₁-C₁₂—, preferably C₁-C₈-alkanols. Particular preference is given to methyl, ethyl, n-butyl, isobutyl, tert-butyl, n-pentyl, isopentyl and 2-ethylhexyl acrylate and/or methacrylate.

Preferably used nitriles are acrylamides and alkyl-substituted acrylamides, such as acrylamide, methacrylamide, N,N-dimethylacrylamide, N-methylolmethacrylamide, N-tert-butylacrylamide, N-methylmethacrylamide, methylenebisacrylamide and mixtures thereof, with acrylamide and methacrylamide being particularly preferred and acrylamide being very particularly preferred.

Preferably used anhydrides are maleic anhydride or derivatives thereof.

The abovementioned monomers may be used in the (co)polymerization process according to the invention on their own or together with other of said monomers.

In a preferred embodiment, the abovementioned allylically or vinylically unsaturated carboxylic acids, in particular acrylic acid and methacrylic acid, very particularly preferably acrylic acid, or ammonium or sodium salts thereof are used on their own or in combination with the abovementioned acrylamides or alkyl-substituted acrylamides, preferably acrylamide or methacrylamid, particularly preferably, acrylamide. Very particular preference is given to copolymerizing ammonium acrylate and acrylamide.

Where necessary, the process according to the invention can be carried out in the presence of further comonomers as well as the monomers already mentioned. Such further suitable comonomers are, for example, sulfo-group-containing monomers, such as allylsulfonic acid, methallylsulfonic acid, styrenesulfonic acid, vinylsulfonic acid, 2-acrylamido-2-methylpropanesulfonic acid, allyloxybenzenesulfonic acid, corresponding alkali metal or ammonium salts thereof, or mixtures thereof, and sulfopropyl acrylate and/or sulfopropyl methacrylate.

Further suitable comonomers are C₁-C₄-hydroxyalkyl esters of C₃-C₆-mono- or dicarboxylic acids, in particular of acrylic acid, methacrylic acid, maleic acid or derivatives thereof alkoxylated with 2 to 50 mol of ethylene oxide, propylene oxide, butylene oxide or mixtures thereof, or esters of C₁-C₁₈-alcohols alkoxylated with 2 to 50 mol of ethylene oxide, propylene oxide, butylene oxide or mixtures thereof with the acids mentioned, such as hydroxyethyl acrylate, hydroxyethyl methacrylate, hydroxypropyl acrylate, hydroxypropyl methacrylate, butane-1,4-diol monoacrylate, ethyl diglycol acrylate, methyl polyglycol acrylate (11 EO), (meth)acrylic esters of C₁₃/C₁₅-oxo alcohol reacted with 3, 5, 7, 10 or 30 mol of ethylene oxide, or mixtures thereof.

In addition, further suitable comonomers are alkylaminoalkyl (meth)acrylates or alkylaminoalkyl (meth)acrylamides or quaternization products thereof, such as 2-(N,N-dimethylamino)ethyl (meth)acrylate or 2-(N,N,N-trimethylammonium)ethyl methacrylate chloride, 3-(N,N-dimethylamino)propyl) methacrylate, 2-dimethylaminoethyl(meth)acrylamide, 3-dimethylaminopropyl(meth)acrylamide, 3-trimethylammoniumpropyl(meth)acrylamide chloride and mixtures thereof.

Also suitable as further comonomers are monomers containing 1,3-diketo groups, such as acetoacetoxyethyl (meth)acrylate or diacetone acrylamide, urea-group-containing monomers, such as ureidoethyl (meth)acrylate, acrylamide glycolic acid, methacrylamidoglycolate methyl ether, monomers containing silyl groups, such as triethoxysilylpropyl methacrylate.

In a preferred embodiment of the process according to the invention, a free-radically polymerizable, preferably allylically or vinylically unsaturated carboxylic acid or salt thereof is homopolymerized or copolymerized together with esters and/or amides of allylically or vinylically unsaturated mono- or dicarboxylic acids. Suitable carboxylic acids, salts thereof, and suitable esters and amides have already been mentioned above. Very particular preference is given to using a mixture of an allylically or vinylically unsaturated carboxylic acid or salt thereof and acrylamides. Preferred allylically or vinylically unsaturated carboxylic acids or salts thereof, and preferred acrylamides have already been mentioned above.

Particular preference is given to using a mixture of acrylic acid or methacrylic acid or ammonium or alkali metal salts thereof and acrylamide or methacrylamide.

Particular preference is given to a mixture of ammonium acrylate and acrylamide.

In addition, it is possible to use, where appropriate, multifunctional comonomers (crosslinkers) which ensure that the resulting (co)polymers crosslink readily.

Suitable crosslinkers are, in particular, methylenebisacrylamide or methacrylamide, esters of unsaturated mono- or polycarboxylic acids of polyols, such as diacrylate or triacrylate, for example butanediol or ethylene glycol diacrylate or methacrylate, and trimethylolpropane triacrylate and allyl compounds, such as allyl (meth)acrylate, triallyl cyanurate, maleic diallyl ester, polyallyl ester, tetraallyloxyethane, triallylamine, tetraallylethylenediamine, allyl ester of phosphoric acid, and vinylphosphonic acid derivatives, as are described, for example, in EP-A 343 427.

Furthermore, reagents which can form crosslinkings as a result of nucleophilic and/or electrophilic addition and/or substitution reactions can also act as crosslinkers. Valid examples here are polyepoxides, polyols, polyaziridines etc.

If a copolymerization is carried out, then use is generally made of
60 to 99.9% by weight, preferably 70 to 99% by weight, particularly preferably 80 to 98% by weight, of at least one free-radically polymerizable water-soluble and/or water-dispersible monomer, preferably at least one, particularly preferably allylically or vinylically unsaturated, carboxylic acid or salt thereof or derivative thereof, very particularly preferably chosen from the group consisting of esters, amides, nitriles and anhydrides or vinylically unsaturated mono- or dicarboxylic acids,
0.1 to 40% by weight, preferably 1 to 30% by weight, particularly preferably 2 to 20% by weight, of at least one further comonomer, and
0 to 5% by weight, preferably 0.1 to 2% by weight, particularly preferably 0.1 to 1% by weight, of at least one multifunctional comonomer (crosslinker),
   where the total sum of the monomers and comonomers is 100% by weight.

Preferred compounds of the compound groups specified in each case have already been mentioned above.

In the process according to the invention, preference is given to using the following monomers:
acrylic acid, methacrylic acid or ammonium or alkali metal salts thereof, preferably ammonium acrylate,
optionally acrylamide, methacrylamide, methyl acrylate, ethyl acrylate, methyl methacrylate or ethyl methacrylate, preferably acrylamide or methacrylamide, particularly preferably acrylamide,
optionally methylenebisacrylamide, polyethylene glycol diacrylate, N,N′-divinylethyleneurea and acrylic esters of glycol, butanediol, trimethylolpropane or glycerol, or acrylic esters of glycol, butanediol, trimethylolpropane or glycerol reacted with ethylene oxide and/or epichlorohydrin.

The (co)polymerization of the monomers and comonomers used takes place by free-radical polymerization as inverse emulsion polymerization in the presence of at least one redox initiator pair and optionally at least one regulator.

The redox initiator pair comprises an oxidizing agent and a reducing agent which, according to the invention, is 2-hydroxy-2-sulfinatoacetic acid and/or salt thereof.

Suitable oxidizing agents for the free-radical polymerization are all oxidizing agents of a redox initiator pair known in the prior art. Preference is given to using persulfates, azo compounds and peroxides or combinations thereof. Suitable peroxides are, for example, hydrogen peroxide, tert-butyl hydroperoxide and tert-amyl hydroperoxide, preferably hydrogen peroxide. Suitable persulfates are alkali metal persulfates, preferably sodium peroxodisulfate. Particular preference is thus given to using, as redox initiator pair, sodium peroxodisulfate or hydrogen peroxide as oxidizing agent and 2-hydroxy-2-sulfinatoacetic acid disodium salt as reducing agent.

In general, the redox initiator pair is used in an amount of from 0.001 to 10% by weight, preferably 0.01 to 5% by weight, based on the amount of the monomers used.

It has been found that the (co)polymerization of the process according to the invention takes place without the occurrence of an induction period even when small amounts of oxidizing component are used. The addition of transition metal compounds for preventing or reducing the induction period is not necessary in the process according to the invention.

The (co)polymerization can optionally also be carried out in the presence of polymerization regulators in order to regulate the molecular weight of the polymers. If it is desired to prepare particularly low molecular weight (co)polymers, relatively large amounts of polymerization regulators are used, whereas for the preparation of high molecular weight (co)polymers, only small amounts of polymerization regulators are used, or the process is carried out in the absence of these substances. Suitable polymerization regulators are compounds with a high transfer constant, such as sulfur-containing compounds, e.g. mercaptans, such as 1-dodecanethiol, 2-mercaptoethanol, mercaptopropanols, mercaptopropionic acid; halomethanes, such as tri-, tetrachloromethane; allyl alcohol; formic acids; aldehydes, such as acetaldehyde and acetates. The polymerization regulators are used in an amount of from 0 to 10% by weight, preferably 0 to 5% by weight, based on the monomers used. In this connection it is to be taken into consideration that the solvent, the initiator and the monomers themselves can also act as chain transfer agents and thus as regulators.

In a preferred embodiment, the process according to the invention comprises the following steps:
a) dissolution of at least one water-in-oil emulsifier or at least one protective colloid in a hydrophobic liquid inert for the polymerization, as a result of which an oil phase is formed,
b) dissolution of the monomers, optionally of the further comonomers, optionally of the at least one crosslinker, at least one water-in-oil emulsifier and of the at least one redox initiator in water, as result of which an aqueous phase is formed,
c) mixing the oil phase and the aqueous phase until the aqueous phase is emulsified in the oil phase,
d) homopolymerization or copolymerization of the monomers used, optionally of the further comonomers and optionally of the at least one crosslinker.

Suitable hydrophobic liquids inert for the polymerization are generally organic solvents, such as aliphatic, cycloaliphatic or aromatic hydrocarbons, for example hexane or heptane, cyclohexane, toluene or xylene. In addition, it is also possible to use organic ether compounds, such as tetrahydrofuran, and halogenated hydrocarbons. In addition, vegetable oils can be used. Furthermore, mineral oils are suitable as inert hydrophobic liquids. Suitable mineral oils are those which consist essentially of liquid distillation products obtained from mineral raw materials, such as crude oil, coal, wood or peat, and which consist primarily of mixtures of saturated hydrocarbons. Examples of such mineral oils are gasoline, diesel oils, heating oils, lubricating oils, illuminating petroleum or insulating oils. As inert hydrophobic liquids, particular preference is given to using mineral oils and petroleum ethers chosen from hydrocarbons.

Suitable water-in-oil emulsifiers are anionic, nonionic, cationic and amphoteric emulsifiers. Suitable anionic emulsifiers are, for example, alkylbenzenesulfonic acids, sulfonated fatty acids, sulfosuccinates, fatty alcohol sulfates, alkylphenolsulfates and fatty alcohol ether sulfates. Suitable nonionic emulsifiers are alkylphenyl ethoxylates, primary alcohol ethoxylates, fatty acid ethoxylates, alcohol amide ethoxylates, fatty amine ethoxylates, ethylene oxide/propylene oxide block copolymers and alkyl polyglycosides. Suitable cationic and amphoteric emulsifiers are quaternized amine alkoxylates, alkylbetaines, alkylamidobetaines and sulfobetaines.

Suitable protective colloids are, for example, cellulose derivatives, polyethylene glycol, polypropylene glycol, copolymers of ethylene glycol and propylene glycol, polyvinyl acetate, polyvinyl alcohol, polyvinyl ether, starch and starch derivatives, dextran, polyvinylpyrrolidone, polyvinylpyridine, polyethylenimine, polyvinylimidazole, polyvinylsuccinimide, polyvinyl-2-methylimidazoline and copolymers containing maleic acid or maleic anhydride as described, for example, in DE-A2 501 123.

The emulsifiers or protective colloids are usually used in an amount of from 0.05 to 40% by weight, preferably 0.05 to 20% by weight, based on the total amount of the monomers used in the (co)polymerization.

If the monomers used are allylically or vinylically unsaturated carboxylic acids, then these can be completely or partially neutralized by bases before or during the (co)polymerization. Suitable bases are, for example, alkali metal or alkaline earth metal compounds, such as sodium hydroxide, potassium hydroxide, calcium hydroxide, magnesium oxide, sodium carbonate; ammonia; primary, secondary and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine or morpholine. Preference is given to using sodium hydroxide and ammonia.

Furthermore, additives customary in the process according to the invention can be used, depending on the intended use of the prepared copolymers and W/O emulsion. For example, depending on the intended use, the use of radiation- and/or thermally-curable materials (crosslinkers), bactericides or biocides is possible. Moreover, hydrophobicizing agents, for example, can be used. Suitable hydrophobicizing agents are customary aqueous paraffin dispersions or silicones. It is also possible to use stabilizers, antifoams, complexing agents, wetting agents, thickeners, dispersions, plasticizers, retention agents, pigments, fillers and further auxiliaries known to the person skilled in the art.

The oil phase comprising at least one water-in-oil emulsifier or at least one protective colloid in a hydrophobic liquid inert for the polymerization is mixed with an aqueous phase comprising the monomers used, optionally the further comonomers, at least one oil-in-water emulsifier and optionally at least one crosslinker and at least one redox initiator in water until the aqueous phase is emulsified in the oil phase. This mixing can take place in any way known to the person skilled in the art. Preference in this regard is given to adding the aqueous phase to the oil phase with stirring. However, another addition sequence is also conceivable.

After the aqueous phase is emulsified in the oil phase, the (co)polymerization of the monomers used and optionally further comonomers takes place. This is generally carried out at temperatures of from 5 to 95° C., preferably 15 to 85° C., particularly preferably 20 to 80° C.

The (co)polymers prepared according to the invention can be isolated by methods known to the person skilled in the art.

Due to the reducing agent used according to the invention, the occurrence of an induction period during the (co)polymerization is avoided. The addition of transition metal compounds is not necessary. In a preferred embodiment of the process according to the invention, no transition metal compounds are therefore added.

The mass ratio of oil phase to aqueous phase in the process according to the invention is generally from 1:19 to 1:2, preferably 1:10 to 1:2, particularly preferably 1:5 to 1:3.

The process according to the invention produces (co)polymers which have excellent product properties, in particular good speck and gel body values, and low residual monomer contents.

The present invention thus further provides homopolymers or copolymers preparable by the process according to the invention. Compared with homopolymers or copolymers which have been prepared by processes according to the prior art, these are notable for excellent product properties. Preferably, the (co)polymers according to the invention have a residual monomer content of at most 5% by weight, preferably at most 3% by weight, particularly preferably at most 1% by weight, based on the total amounts of the (co) polymers.

Preferred and particularly preferred (co)polymers are obtained when the preferred and particularly preferred monomers and optionally further comonomers are used. Very particular preference is thus given to obtaining copolymers of ammonium acrylate and acrylamide which are optionally slightly crosslinked.

The (co)polymers according to the invention are preferably used in W/O emulsions. The present application therefore further relates to water-in-oil emulsions (WIO emulsions) comprising an oil phase which comprises at least one water-in-oil emulsifier or at least one protective colloid in an inert hydrophobic liquid, and an aqueous phase emulsified in the oil phase which comprises at least one homopolymer or copolymer according to the invention and at least one oil-in-water emulsifier. The W/O emulsions according to the invention are obtained directly using the process according to the invention, without the need for further processing or isolation of the resulting (co)polymer. Suitable inert hydrophobic liquids, water-in-oil emulsifiers, protective colloids, and suitable (co)polymers have already been mentioned above. The W/O emulsions according to the invention can also comprise customary additives, depending on the intended use. Suitable customary additives have been specified above.

The W/O emulsions according to the invention are notable in particular for low speck contents.

The present application thus further provides a W/O emulsion according to the invention which has a speck content of at most 0.5% by weight, preferably at most 0.1% by weight, particularly preferably at most 0.01% by weight, based on the total mass of the W/O emulsion.

The W/O emulsion according to the invention preferably comprises
0.1 to 8% by weight, preferably 0.5 to 5% by weight, particularly preferably 1 to 5% by weight, of at least one water-in-oil emulsifier or at least one protective colloid,
0.1 to 8% by weight, preferably 0.5 to 5% by weight, particularly preferably 1 to 5% by weight, of at least one oil-in-water emulsifier (wetting agent),
5 to 50% by weight, preferably 10 to 40% by weight, particularly preferably 20 to 30% by weight, of at least one homopolymer or copolymer according to the invention,
10 to 40% by weight, preferably 15 to 30% by weight, particularly preferably 15 to 25% by weight, of an inert hydrophobic liquid,
10 to 60% by weight, preferably 20 to 50% by weight, particularly preferably 30 to 50% by weight, of an aqueous phase,
0 to 20% by weight, preferably 0.5 to 15% by weight, particularly preferably 1 to 10% by weight, of auxiliaries and customary additives;
   where the total sum of said components is 100% by weight.

It is likewise possible to remove the inert hydrophobic liquid and the water after the (co)polymerization according to the process of the invention. The removal takes place here by methods known to the person skilled in the art. In the process, a solid composition is obtained which comprises at least one water-in-oil emulsifier or at least one protective colloid, at least one oil-in-water emulsifier (wetting agent) and at least one homopolymer or copolymer according to the invention, and optionally customary additives. The present invention therefore further provides solid compositions comprising at least one water-in-oil emulsifier or at least one protective colloid and at least one homopolymer or copolymer according to the invention, and optionally customary additives. Suitable customary additives are mentioned above.

The solid composition according to the invention preferably comprises
0.2 to 16% by weight, preferably 1.0 to 10% by weight, particularly preferably 2 to 10% by weight, of at least one water-in-oil emulsifier or at least one protective colloid,
0.2 to 16% by weight, preferably 1 to 10% by weight, particularly preferably 2 to 10% by weight, of at least one oil-in-water emulsifier (wetting agent) and
10 to 99.6% by weight, preferably 20 to 79.7% by weight, particularly preferably 40 to 60% by weight, of at least one homopolymer or copolymer according to the invention,
0 to 40% by weight, preferably 1.0 to 30% by weight, particularly preferably 2 to 20% by weight, of customary additives
   where the total sum of the components is 100% by weight.

These solid compositions can be converted into W/O emulsions by adding an inert hydrophobic liquid and water. The compositions of such W/O emulsions have already been specified above.

The present invention further provides for the use of 2-hydroxy-2-sulfinatoacetic acid or salt thereof as reducing agent in a process for the preparation of homopolymers or copolymers by homopolymerization or copolymerization of free-radically polymerizable carboxylic acids, or salts or derivatives thereof as monomers, optionally with further comonomers and optionally at least one crosslinker in an inverse emulsion polymerization in the presence of at least one redox initiator pair comprising an oxidizing agent and a reducing agent. Preferably used salts of 2-hydroxy-2-sulfinatoacetic acid, monomers, optionally further comonomers and optionally used crosslinkers, and preferred conditions and components of the inverse emulsion polymerization and preferred oxidizing agents have already been specified above. The reducing agent used is particularly preferably 2-hydroxy-2-sulfinatoacetic acid disodium salt.

By using the 2-hydroxy-2-sulfinatoacetic acid or salt thereof, a polymerization of said monomers and optionally comonomers is possible without the occurrence of an induction period even when the amounts of oxidizing component are small. Suitable amounts of oxidizing and reducing component and of the other components have already been specified above. The use of transition metals for avoiding or shortening the induction period is not necessary. The use according to the invention thus preferably takes place without the addition of transition metal compounds. By means of the use according to the invention, (co)polymers are obtained which have advantageous product properties, in particular good speck and gel body values.

The water-in-oil emulsions comprising the (co)polymers according to the invention are generally used for thickening aqueous solutions. In this regard, an aqueous solution is admixed with the WIO emulsion according to the invention, as a result of which, following inversion to an oil-in-water emulsion (O/W emulsion), the (co)polymers according to the invention are released, as a result of which a thickening effect is brought about.

The present invention thus further provides for the use of the water-in-oil emulsions or of water-in-oil emulsions according to the invention and comprising the (co)polymer according to the invention for thickening aqueous solutions, preferably for thickening printing pastes.

On the basis of the use according to the invention, printing pastes with low gel body contents are obtainable.

The present application thus further provides printing pastes comprising homopolymers or copolymers according to the present application which have a gel body content of at most 0.5% by weight, preferably at most 0.15% by weight, based on the total mass of the printing paste.

In the case of use for the thickening of printing pastes, in particular in the textile industry sector an aqueous solution of pigments is admixed with a W/O emulsion according to the invention or a W/O emulsion which comprises at least one (co)polymer according to the invention, as a result of which, following inversion to an O/W emulsion, a thickening effect is brought about as a result of the release of the (co)polymers according to the invention. This thickening effect is exploited in order to ensure a sharp contour during textile printing. Through the use of the (co)polymers according to the invention or the W/O emulsions according to the invention, a speck and/or gel body formation is avoided or reduced compared with (co)polymers known from the prior art.

Further aqueous solutions as well as printing pastes in which the W/O emulsions according to the invention or the (co)polymers according to the invention in W/O emulsions are used for the thickening of water-containing systems are, for example, aqueous solutions in the field of cosmetics, skincare or haircare. Furthermore, the W/O emulsions according to the invention and the copolymers according to the invention can be used in aqueous solutions for the impregnation of hydrophilicizable materials such as leather, paper, textiles, nonwovens, and in applications in the agrochemical sector.

The present invention further provides the use of 2-hydroxy-2-sulfinatoacetic acid or salt thereof, preferably disodium salt, as reducing component of a redox initiator pair comprising an oxidizing agent and a reducing agent for avoiding incubation periods during the inverse emulsion polymerization of free-radically polymerizable water-soluble and/or water-dispersible monomers, preferably allylically or vinylically unsaturated carboxylic acids, or salts or derivatives thereof as monomers, optionally with further comonomers, with no transition metal compounds being added. By means of the use of 2-hydroxy-2-sulfinatoacetic acid or salt thereof as reducing component it is possible to avoid induction periods during the inverse emulsion polymerization and thus to prepare (co)polymers with excellent product properties, in particular good speck and gel body values. Preferred monomers, optionally used comonomers, oxidizing components and reaction conditions have already been specified above. The reducing component used is preferably 2-hydroxy-2-sulfinatoacetic acid disodium salt.

The examples below additionally illustrate the invention.

### EXAMPLES

a) Definitions

Specks:

Polymer particles which arise during the polymerization and exceed a certain size. They are separated off by filtration during purification of the W/O emulsion. High speck contents thus result in increased production costs due to increased filtration expenditure. The specks are determined by means of filtration of the W/O emulsion through a 125 μm filter following its preparation. The speck content is given in % of the total mass of the W/O emulsion.

Gel Bodies:

Particles which form during use, i.e. during inversion of the W/O emulsion for the preparation of the printing paste, and exceed a certain size. The gel bodies are determined by means of inversion by stirring 100 g of a W/O emulsion in 8/demineralized water and 2 g of Luprintol PE new, subsequent compressive filtration of this paste through a gauze with a pore size of 80 μm, and dewatering and final weighing of the residue. The data is in % of the particular paste.

Through the use of 2-hydroxy-2-sulfinatoacetic acid, or salt thereof, in particular 2-hydroxy-2-sufinatoacetic acid disodium salt (=Brüggolite FF6) from Brüggemann Chemical as reducing component it was possible to find a method in which, even in the case of small amounts of oxidizing component, no induction period at all arises and the emulsion polymers have advantageous application properties.

This permits the development of a transition-metal-free preparation method of W/O emulsions which have low speck and gel body numbers while retaining the specification-relevant properties.

### General Procedure for Examples 1 to 7

In a stirred vessel 407 g of distilled water were mixed with 300 g of acrylic acid (100% strength) and also 284 g of a 50% strength aqueous solution of ammonia, 75 g of a 50% strength aqueous solution of acrylamide, 279 of a 1% strength aqueous solution of methylenebisacrylamide, 7.08 g of a 0.4% strength aqueous solution of Trilon D, 6.75 g of a 1% strength aqueous solution of formic acid and the amount of a 1% strength aqueous solution of Brüggolite FF6 given in Table 1. After the aqueous phase had been neutralized with the ammonia present, it was placed in a second sealed stirred vessel (2 liter HWS, with anchor stirrer), which contained an organic phase comprising 300 g of Shellsol D70 (100% strength).

With nitrogen gassing (at 15 liters/hour) and water bath cooling, the combined aqueous and organic phases were then preemulsified in the second stirred vessel at 400 revolutions per minute for 60 minutes. Subsequently, the speed of the stirrer was reduced to 200 revolutions per minute, the mixture was heated to 31° C., and a feed of an amount of a 10% strength aqueous sodium persulfate solution given in Table 1 was added and the polymerization was thereby started.

The starting temperature here was 31.0° C. The polymerization started immediately and reached a maximum temperature given in Table 1. After the temperature had dropped by 1° C., a further feed of 16.88 g of a 10% strength aqueous sodium persulfate solution was added and, 10 minutes later, 11.81 g of a 10% strength aqueous Rongalit solution were again added. This gives an emulsion of mineral oil, water and carboxyl-group-rich copolymers of acrylic acid.

The following meanings apply here:
Shellsol D 70 (mineral oil from Shell AG)
Span 80 (emulsifier from Uniqema based on sorbitan monooleate)
Lutensol LF 400 (emulsifier from BASF Aktiengesellschaft, based on epoxidized and propoxylated, primarily linear alcohols) Triton® D (complexing agent from BASF Aktiengesellschaft, based on the trisodium salt of hydroxyethylenediaminetriacetic acid in water)
Rongalit® C (reducing agent from BASF Aktiengesellschaft, based on the sodium salt of hydroxymethanesulfinic acid)

Brüggolite FF6 reducing agent from Brüggemann Chemical based on 2-hydroxy-2-sulfinatoacetic acid, disodium salt

TABLE 1

| | | Amount of sodium | | | |
|---|---|---|---|---|---|
| | | persulfate prior | | | |
| | Amount of | to the start of | | | Gel |
| | Brüggolite | the polymerization | Tₘₐₓ | Specks | bodies |
| Example | FF6 [g] | [g] | [° C.] | [%] | [%] |
| 1 | 0.67 | 5.06 | 77.8 | 0.01 | 0.24 |
| 2 | 1.35 | 5.06 | 80.0 | 0.01 | 0.07 |
| 3 | 1.69 | 5.06 | 80.5 | 0.01 | 0.02 |
| 4 | 2.03 | 5.06 | 82.3 | 0.01 | 0.01 |
| 5 | 1.35 | 4.22 | 77.6 | 0.01 | 0.01 |
| 6 | 1.35 | 3.38 | 76.6 | <0.01 | 0.01 |
| 7 | 1.35 | 2.53 | 76.7 | <0.01 | 0.01 |

### General Procedure for Examples 8 to 20

In a stirred vessel 274 g of distilled water were mixed with 200 g of acrylic acid (100% strength) and also 189 g of a 50% strength aqueous solution of ammonia, 50 g of a 50% strength aqueous solution of acrylamide, 18 g of a 1% strength aqueous solution of methylenebisacrylamide, 4.72 g of 0.4% strength aqueous. solution of Trilon D, 4.5 g of a 1% strength aqueous solution of formic acid and the amount of a 1% strength aqueous solution of Brüggolite FF6 given in Table 2. After the aqueous phase had been neutralized with the ammonia present, it was placed in a second sealed stirred vessel (2 liter HWS, with anchor stirrer) which contained an organic phase of 200 g of Shellsol D 70 (100% strength), 20 g of Lutensol LF 400 (100% strength) and 17.5 g of Span 80 (100% strength). With nitrogen gassing (with 15 liters/hour) and water bath cooling, the combined aqueous and organic phases were then preemulsified in the second stirred vessel at 400 revolutions per minute for 60 minutes. Subsequently the speed of the stirrer was reduced to 200 revolutions per minute, the mixture was heated to 31° C., and a feed of the amount of an oxidizing agent given in Table 2 was added and the polymerization was thereby started.

The starting temperature here was 31.0° C. The polymerization started immediately and reached a temperature given in Table 2. After the temperature had dropped by 1° C., a further feed of the amount of an oxidizing agent given in Table 2 was added and, 10 minutes later, 7.88 g of a 10% strength aqueous Rongalit solution were again added. This gives an emulsion of mineral oil, water and carboxyl-group-rich copolymers of acrylic acid.

TABLE 2

| | Amount of | Amount [g] and type of | Amount [g] and type of the | | | Gel |
|---|---|---|---|---|---|---|
| | Brüggolite | oxidizing agent prior to the | oxidizing agent used after the | Tₘₐₓ | Specks | bodies |
| Example | FF6 [g] | start of the polymerization | start of the polymerization | [° C.] | [%] | [%] |
| 8 | 0.90 | 0.90; 10% strength aqueous | 11.25; 10% strength aqueous | 67.0 | <0.01 | 0.01 |
| | | sodium persulfate solution | sodium persulfate solution | | | |
| 9 | 0.90 | 0.68; 10% strength aqueous | 11.25; 10% strength aqueous | 67.7 | <0.01 | 0.01 |
| | | sodium persulfate solution | sodium persulfate solution | | | |
| 10 | 1.13 | 2.25; 10% strength aqueous | 11.25; 10% strength aqueous | 69.4 | <0.01 | 0.01 |
| | | sodium persulfate solution | sodium persulfate solution | | | |
| 11 | 1.13 | 1.91; 10% strength aqueous | 11.25; 10% strength aqueous | 57.1 | 0.01 | 0.28 |
| | | sodium persulfate solution | sodium persulfate solution | | | |
| 12 | 1.13 | 2.25; 10% strength aqueous | 11.25; 10% strength aqueous | 58.5 | 0.01 | 0.09 |
| | | sodium persulfate solution | sodium persulfate solution | | | |
| 13 | 1.13 | 2.59; 10% strength aqueous | 11.25; 10% strength aqueous | 62.8 | <0.01 | 0.01 |
| | | sodium persulfate solution | sodium persulfate solution | | | |
| 14 | 1.13 | 0.97; 3% strength aqueous | 4.83; 3% strength aqueous | 53.7 | <0.01 | 0.01 |
| | | hydrogen peroxide solution | hydrogen peroxide solution | | | |
| 15 | 1.13 | 1.45; 3% strength aqueous | 4.83; 3% strength aqueous | 54.0 | <0.01 | 0.01 |
| | | hydrogen peroxide solution | hydrogen peroxide solution | | | |
| 16 | 1.13 | 0.97; 3% strength aqueous | 4.83; 3% strength aqueous | 53.7 | <0.01 | 0.03 |
| | | hydrogen peroxide solution | hydrogen peroxide solution | | | |
| 17 | 1.13 | 0.49; 3% strength aqueous | 11.25; 10% strength aqueous | 59.5 | 0.05 | 0.09 |
| | | hydrogen peroxide solution | sodium persulfate solution | | | |
| 18 | 1.13 | 0.25; 3% strength aqueous | 11.25; 10% strength aqueous | 59.1 | 0.02 | 0.06 |
| | | hydrogen peroxide solution | sodium persulfate solution | | | |
| 19 | 1.13 | 0.13; 3% strength aqueous | 11.25; 10% strength aqueous | 55.6 | <0.01 | 0.01 |
| | | hydrogen peroxide solution | sodium persulfate solution | | | |
| 20 | 1.13 | 1.28; 3% strength aqueous | 4.84; 3% strength aqueous | 55.4 | <0.01 | 0.13 |
| | | hydrogen peroxide solution | hydrogen peroxide solution | | | |

### General procedure for Examples 21 to 26

In a stirred vessel 261.4 g of distilled water were mixed with 200 g of acrylic acid (100% strength) and also 188 g of a 50% strength aqueous solution of ammonia, 50 g of a 50% strength aqueous solution of acrylamide, a crosslinker given in Table 3 4.72 g of a 0.4% strength aqueous solution of Trilon D, a regulator given in Table 3 and 0.90 g of a 1% strength aqueous solution of Brüggolite FF6. After the aqueous phase had been neutralized with the ammonia present it was placed in a second sealed stirred vessel (2 liter HWS, with anchor stirrer) which contained an organic phase of 200 g of Shellsol D 70 (100% strength), 20 g of Lutensol LF 300 (100% strength) and 17.5 g of Span 80 (100% strength).

With nitrogen gassing (with 15 liters/hour) and water bath cooling, the combined aqueous and organic phases were then preemulsified in the second stirred vessel at 400 revolutions per minute for 60 minutes. Subsequently, the speed of the stirrer was reduced to 200 revolutions per minute, the mixture was heated to 31° C., and a feed of 0.90 g of a 10% strength aqueous sodium persulfate solution was added and the polymerization was thus started.

The starting temperature here was 31.0° C. The polymerization started immediately and reached a maximum temperature given in Table3. After the temperature had dropped by 1° C., a further feed of 11.25 g of a 10% strength aqueous sodium persulfate solution was added and, 10 minutes later, 7.88 g of a 10% strength aqueous Rongalit solution were again added. This gives an emulsion of mineral oil, water and carboxyl-group-rich copolymers of acrylic acid.

TABLE 3

| Exam- | Regulator | Crosslinker | | | Gel |
|---|---|---|---|---|---|
| ple | [g] | [g] | Tₘₐₓ | Specks | bodies |
| 21 | 2.25 g of a | 33.75 g of a | 63.3 | <0.01 | 0.07 |
| | 1% strength | 1% strength | | | |
| | aqueous | aqueous | | | |
| | solution of | solution of | | | |
| | formic acid | methylenebis- | | | |
| | | acrylamide | | | |
| 22 | 3.38 g of a | 33.75 g of a | 63.6 | <0.01 | 0.09 |
| | 1% strength | 1% strength | | | |
| | aqueous | aqueous | | | |
| | solution of | solution of | | | |
| | formic acid | methylenebis- | | | |
| | | acrylamide | | | |
| 23 | 4.50 g of a | 33.75 g of a | 63.6 | not de- | 0.02 |
| | 1% strength | 1% strength | | termined | |
| | aqueous | aqueous | | | |
| | solution of | solution of | | | |
| | formic acid | methylenebis- | | | |
| | | acrylamide | | | |
| 24 | 4.50 g of a | 0.50 g of | 64.7 | <0.01 | 0.01 |
| | 1% strength | Laromer | | | |
| | aqueous | LR 8765 | | | |
| | solution of | | | | |
| | formic acid | | | | |
| 25 | 4.50 g of a | 0.75 g of | 65.8 | 0.01 | 0.02 |
| | 1% strength | Laromer | | | |
| | aqueous | LR 8765 | | | |
| | solution of | | | | |
| | formic acid | | | | |
| 26 | 4.50 g of a | 1.25 g of | 67.2 | 0.01 | 0.08 |
| | 1% strength | Laromer | | | |
| | aqueous | LR 8765 | | | |
| | solution of | | | | |
| | formic acid | | | | |

### General Procedure for Examples 27 to 29

In a stirred vessel 273.5 g of distilled water were mixed with 200 g of acrylic acid (100% strength) and also 188 g of a 50% strength aqueous solution of ammonia, 50 g of a 50% strength aqueous solution of acrylamide, 18 g of a 1% strength aqueous solution of methylenebisacrylamide, 4.80 g of a 0.4% strength aqueous solution of Trilon C, 4.5 g of a 1% strength aqueous solution of formic acid and 1.13 g of a 1% strength aqueous solution of Brüggolite FF6. After the aqueous phase had been neutralized with the ammonia present it was placed in a second sealed stirred vessel (2 liter HWS, with anchor stirrer) which contained an organic phase of an amount of Shellsol D 70 (100% strength) given in Table 4, 20 g of Lutensol LF 300 (100% strength) and an amount of Span 80 (100% strength) given in Table 4.

With nitrogen gassing (with 15 liters/hour) and water bath cooling, the combined aqueous and organic phases were then preemulsified in the second stirred vessel at 400 revolutions per minute for 60 minutes. Subsequently, the speed of the stirrer was reduced to 200 revolutions per minute, the mixture was heated to 28° C., and a feed of 1.91 g of a 10% strength aqueous sodium persulfate solution was added and the polymerization was thus started.

The starting temperature here was 28° C. The polymerization started immediately and reached a temperature given in Table 4. After the temperature had dropped by 1° C., a further feed of 11.25 g of a 10% strength aqueous sodium persulfate solution was added and, 10 minutes later, 7.88 g of a 10% strength aqueous Rongalit solution were again added. This gives an emulsion of mineral oil, water and carboxyl-group-rich copolymers of acrylic acid.

TABLE 4

| | Amount of | | | |
|---|---|---|---|---|
| Example | Shellsol D70 | Tₘₐₓ | Specks | Gel bodies |
| 27 | 180 | 50.5 | 0.02 | 0.52 |
| 28 | 170 | 53.7 | 0.02 | 0.45 |
| 29 | 160 | 54.4 | 0.02 | 0.50 |

### General Procedure for Examples 30 to 42

In a stirred vessel 293.5 g of distilled water were mixed with 200 g of acrylic acid (100% strength) and also the amount of a 50% strength aqueous solution of ammonia given in Table 5, 50 g of a 50% strength aqueous solution of acrylamide, optionally one or more of the further monomers given in Table 5, 18 g of a 1% strength aqueous solution of methylenebisacrylamide, 4.80 g of a 0.4% strength aqueous solution of Trilon C, 4.5 g of a 1% strength aqueous solution of formic acid and 1.13 g of a 1% strength aqueous solution of Brüggolite FF6. After the aqueous phase had been neutralized with the ammonia present, it was placed in a second sealed stirred vessel (2 liter HWS, with anchor stirrer), which contained an organic phase of 190 g of Shellsol D 70 (100% strength), 20 g of Lutensol LF 300 (100% strength) and an amount of Span 80 (100% strength) given in Table 5.

Under nitrogen gassing (with 15 liters/hour) and water bath cooling, the combined aqueous and organic phases were then preemulsified in the second stirred vessel at 400 revolutions per minute for 60 minutes. Subsequently, the speed of the stirrer was reduced to 200 revolutions per minute, the mixture was heated to 30° C. and a feed of 1.91 g of a 10% strength aqueous sodium persulfate solution was added and the polymerization was thus started.

The starting temperature here was 300C. The polymerization started immediately and reached a temperature given in Table 4. After the temperature had dropped by 1° C., a further feed of 11.25 g of a 10% strength aqueous sodium persulfate solution was added and, 10 minutes later, 7.88 g of a 10% strength aqueous Rongalit solution were again added. This gives an emulsion of mineral oil, water and carboxyl-group-rich copolymers of acrylic acid.

TABLE 5

| | Amount of | First additional | Second additional | Amount of | |
|---|---|---|---|---|---|
| Example | Span 80 | monomer | monomer | ammonia [g] | Tₘₐₓ |
| 30 | 17.5 | 10 g of hydroxyethyl | — | 186 | 55.4 |
| | | acrylate (100% strength) | | | |
| 31 | 17.5 | 10 g of hydroxypropyl | — | 186 | 53.5 |
| | | acrylate (100% strength) | | | |
| 32 | 17.5 | 20 g of maleic | — | 186 | 46.5 |
| | | anhydride (100% strength) | | | |
| 33 | 21.75 | 25 g of hydroxyethyl | 5 g of diethylene | 186 | 54.2 |
| | | acrylate (100% strength) | glycol monovinyl ether | | |
| 34 | 21.75 | 20 g of hydroxyethyl | 20 g of lysine monohydrate | 181 | 65.6 |
| | | acrylate (100% strength) | (100% strength) | | |
| 35 | 21.75 | 20 g of hydroxyethyl | 20 g of | 181 | 68.3 |
| | | acrylate (100% strength) | 4,9-dioxadodecane-1,12-diamine | | |
| | | | (100% strength) | | |
| 36 | 21.75 | 25 g of an 80% strength aqueous | 25 g of lysine monohydrate | 180 | 66.7 |
| | | solution of dimethylaminoethyl | (100% strength) | | |
| | | acrylate methochloride | | | |
| 37 | 21.75 | 25 g of an 80% strength aqueous | 20 g of octamethylenediamine | 170.5 | 71.3 |
| | | solution of dimethylaminoethyl | (100% strength) | | |
| | | acrylate methochloride | | | |
| 38 | 21.75 | 20 g of an 80% strength aqueous | 20 g of hydroxyethyl acrylate | 176 | 70.3 |
| | | solution of dimethylaminoethyl | (100% strength) | | |
| | | acrylate methochloride | | | |
| 39 | 21.75 | 20 g of an 80% strength aqueous | 20 g of hydroxyethyl acrylate | 164 | 70.3 |
| | | solution of dimethylaminoethyl | (100% strength) | | |
| | | acrylate methochloride | 20 g of hexamethylenediamine | | |
| | | | (100 strength) | | |
| 40 | 21.75 | 25 g of an 80% strength aqueous | 25 g of hydroxyethyl acrylate | 186 | 71.3 |
| | | solution of dimethylaminoethyl | (100% strength) | | |
| | | acrylate methochloride | | | |
| 41 | 21.75 | 45 g of an 80% strength aqueous | — | 186 | 65.3 |
| | | solution of dimethylaminoethyl | | | |
| | | acrylate methochloride | | | |
| 42 | 21.75 | 40 g of dimethylaminoacrylate | — | 172.1 | 81.9 |
| | | (100% strength) | | | |

1. A process for the preparation of water-soluble or water-swellable homopolymers or copolymers by homopolymerization or copolymerization of free-radically polymerizable water-soluble and/or water-dispersible monomers, optionally with further comonomers and optionally at least one crosslinker, in an inverse emulsion polymerization in the presence of at least one redox initiator pair comprising an oxidizing agent and a reducing agent, wherein the reducing agent is 2-hydroxy-2-sulfinatoacetic acid and/or salt thereof.

2. A process as claimed in claim 1, wherein free-radically polymerizable carboxylic acids, or salts or derivatives thereof are used as monomers.

3. A process as claimed in claim 1, wherein a mixture of acrylic acid and/or salt thereof and acrylamide is used as monomers.

4. A process as claimed in claim 1, comprising the following steps:
a) dissolution of at least one water-in-oil emulsifier or at least one protective colloid in a hydrophobic liquid inert for the polymerization as a result of which an oil phase is formed,
b) dissolution or dispersion of the monomers and optionally further comonomers, an oil-in-water emulsifier and the at least one redox initiator in water, as result of which an aqueous phase is formed,
c) mixing of the oil phase and the aqueous phase until the aqueous phase is emulsified in the oil phase,
d) homopolymerization or copolymerization of the monomers used and optionally further comonomers.

5. A process as claimed in claim 1, wherein no transition metal compounds are added in the process.

6. A homopolymer or copolymer preparable by a process of claim 1.

7. A homopolymer or copolymer as claimed in claim 6, which has a residual monomer content of at most 5% by weight, preferably at most 1% by weight, particularly preferably of at most 0.1% by weight, based on the total mass of the homopolymer or copolymer.

8. A water-in-oil emulsion comprising an oil phase which comprises at least one water-in-oil emulsifier or at least one protective colloid in an inert hydrophobic liquid, and an aqueous phase emulsified in the oil phase which comprises at least one homopolymer or copolymer as claimed in claim 6.

9. A water-in-oil emulsion as claimed in claim 8, which has a speck content of at most 0.5%, preferably at most 0.01%, based on the total mass of the W/O emulsion.

10. A solid composition comprising at least one water-in-oil emulsifier or at least one protective colloid, at least one oil-in-water emulsifier and at least one homopolymer or copolymer as claimed in claim 6.

11-13. (canceled)

14. A printing paste comprising homopolymer or copolymer as claimed in claim 6, which has a gel body content of at most 0.5%, preferably 0.15%, based on the total mass of the printing paste.

15. (canceled)

16. A method of avoiding induction times during the inverse emulsion polymerization of free-radically polymerizable water-soluble and/or water-dispersible monomers, optionally with further comonomers, during which no transiation metal compounds are added, comprising the step of 2-hydorxy-2-sulfinatoactic acid and/or salt therof as reducing component or a redox initiator pair comprising an oxidizing agent and a reducing agent.

17. A method of thickening printing pastes comprising the step of adding a water-in-oil emulsion as claimed in claim 8.

18. A method of thickening printing pastes comprising the step of adding a homopolymer or a copolymer as claimed in claim 6.

19. A process as claimed in claim 2, wherein a mixture of acrylic acid and/or salt thereof and acrylamide is used as monomers.

20. A process as claimed in claim 2, comprising the following steps:
a) dissolution of at least one water-in-oil emulsifier or at least one protective colloid in a hydrophobic liquid inert for the polymerization as a result of which an oil phase is formed,
b) dissolution or dispersion of the monomers and optionally further comonomers, an oil-in-water emulsifier and the at least one redox initiator in water, as result of which an aqueous phase is formed,
c) mixing of the oil phase and the aqueous phase until the aqueous phase is emulsified in the oil phase,
d) homopolymerization or copolymerization of the monomers used and optionally further comonomers.

21. A process as claimed in claim 3, comprising the following steps:
a) dissolution of at least one water-in-oil emulsifier or at least one protective colloid in a hydrophobic liquid inert for the polymerization as a result of which an oil phase is formed,
b) dissolution or dispersion of the monomers and optionally further comonomers, an oil-in-water emulsifier and the at least one redox initiator in water, as result of which an aqueous phase is formed,
c) mixing of the oil phase and the aqueous phase until the aqueous phase is emulsified in the oil phase,
d) homopolymerization or copolymerization of the monomers used and optionally further comonomers.

22. A process as claimed in claim 2, wherein no transition metal compounds are added in the process.

23. A process as claimed in claim 3, wherein no transition metal compounds are added in the process.

24. A process as claimed in claim 4, wherein no transition metal compounds are added in the process.
